(19) United States
(12) Patent Application Publication
(10) Pub. No.: US 2012/0264428 A1
(43) Pub. Date: Oct. 18, 2012

(54) NETWORK SELECTION

(76) Inventors: David Lecompte, Berkshire (GB); Iskren Ianev, Berkshire (GB)

(21) Appl. No.: 13/513,168

(22) PCT Filed: Dec. 8, 2010
(86) PCT No.: PCT/JP2010/072509

§ 371 Date: Jun. 18, 2012

(30) Foreign Application Priority Data
Jan. 11, 2010 (GB) 1000345.7

(51) Int. Cl. H04W 8/00

(52) U.S. Cl. 455/435.1

(57) ABSTRACT

The present invention provides for method of selection by a User Device of a desired PLMN offering a desired service, such as emergency bearer services, from a list of PLMNs within a shared network environment, the method includes creating a list of network identifiers for the said plurality of PLMNs respectively, and locating the identifier of the said desired PLMN at a predetermined position within the said list. Related User Devices and network node devices are also provided.

### NETWORK SELECTION

This application is based upon and claims the benefit of priority from UK Patent Application No. 1000345.7 filed on Jan. 11, 2010, the content of which is incorporated by reference.

### TECHNICAL FIELD

The present invention relates to network selection and, in particular, to a method of assisting such selection and a mobile radio communications user device, and mobile radio communications network device arranged for the same.

### BACKGROUND ART

To reduce network deployment costs, a single mobile radio communications network device often has the potential to access one of a plurality of networks and, in particular, Public Land Mobile Networks (PLMNs).

In scenarios where a plurality of networks are available through a single mobile radio communication network device, problems can arise through discrepancies between the network that is most likely to be selected by the user device, and the network that might be preferred, or might be most likely to be selected, by the radio network communication device. Any such discrepancy can have a potentially disadvantageous impact upon the ongoing operability of the user device. Further security and authentication requirements may not be met.

### SUMMARY OF INVENTION

The present invention seeks to provide for a method of network selection, and related operability for a mobile radio communications user device and a mobile radio communications network device providing access to a plurality of networks, having advantages over known such devices.

In particular, the present invention can seek to overcome problems known in the current art having regard to requirements for connectivity security and authentication.

The above-mentioned problems and limitations as found in the current art are particularly prevalent in scenarios in which it is required that emergency bearer services are supported for Use Equipment (UE) operating in limited service mode and in which selection of one of a plurality of networks is required for access to the emergency bearer service.

For example, IP Multimedia Subsystem (IMS) emergency calls are supported in accordance with 3GPP Rel-9 specifications. That is, IMS emergency call support indication can be arranged to be broadcast by each cell via the available System Information (SI) such that any UEs operating in a limited service mode can select a different cell if IMS emergency services are not supported by the current cell

Further details and requirements for such IMS emergency call support are found within 3GPP Technical Specification 36.300 at section 23.1.1 and wherein the IMS emergency call support indicator in the SI is set to “true” if any of the Mobility Management Entities (MMEs) in a non-shared environment, or if one of the PLMNs in a shared network environment, supports IMS emergency bearer services.

With regard to 3GPP specifications relating to E-UTRAN, such as Technical Specification identified as TS 36.300 section 10.1.7, if the E-UTRAN is shared by multiple operators, the SI broadcast in each shared cell contains the PLMN identification of each operator. As discussed in the aforementioned Technical Specification, there can be up to six operators sharing the E-UTRAN. However, in so far as there can be up to six PLMNs sharing the cell and, as noted, only a single bit is used for an indication of IMS emergency support, this can lead to potential problems and related limitations and as discussed in the Liaison Statement (LS) from 3GPP SA2, i.e. S2-096386. This LS identifies a scenario in which a UE in limited service mode and camping on a shared E-UTRAN cell, broadcasts its support for IMS emergency services by way of a single bit identifier. If an emergency bearer service is required, the UE can issue an emergency attach signal towards one of the PLMNs within the shared E-UTRAN cell. However, the eNB within this cell automatically seeks to select a MME of the PLMN that supports emergency bearer services but which is most likely different from the PLMN with which the UE has initiated its emergency attach procedure.

However, after a subsequent authentication procedure, the UE and the MME/HSS employ different PLMN identifiers as input to the master key K_ASME derivation. While the authentication procedure will complete successfully, the UE will fail to decode any further message from the MME and the MME will fail to decode any message from the UE.

While various attempts have been made to overcome, or at least limit such problems, none seek to achieve this goal without introducing further, or associated, limitations and problems. For example, recent discussions within 3GPP RAN 2 lead to the proposal of providing an indication of support for emergency calls for each of the shared PLMNs though of course it is appreciated that this would disadvantageously the lead to an increase in SI size since six bits would then be required, rather than the current single bit, for providing the relevant emergency services. In particular, the size of broadcast data elements remains an important consideration as these elements are transmitted permanently and frequently so as to allow fast access by any user device entering a cell. Increasing the size of broadcast data elements reduces network capacity so it is desirable to keep them as short as possible.

Further, and as discussed in the above mentioned LS S2-096386, a possible, but limited requirement would be to have all PLMNs within a shared E-UTRAN employ the same IMS emergency support. This would of course prevent the eNB from selecting a different PLMN.

The present invention seeks to provide for a method, and related network and UE devices for assisting with PLMN selection when the UE is operating in a limited service mode within a shared network environment and, in particular, when seeking to place an IMS emergency call by way of an appropriate PLMN.

According to a first aspect of the present invention, there is provided a method of assisting selection by a mobile radio communications device of a desired network from a plurality of networks in a multi-network environment, the method including creating a structured representation of network identifiers for the said plurality of networks respectively. and locating the identifier of the said desired network at a predetermined position within the said structured representation.

The invention proves advantageous in as much as a network having the required characteristic, for example the support of IMS emergency bearer services, can then be readily selected by the user device such that there are no discrepancies between the desired, and selected, networks so as to avoid the limitations and disadvantages that have been identified within the current art.

According to another aspect of the present invention, there is provided a mobile radio communication network device arranged to operate in a multi-network environment and for assisting selection by a mobile radio communication user device of a desired network from a plurality of networks available through the same mobile radio communications network device, the device further being arranged to create a structured representation of network identifiers for the said plurality of networks respectively, and to locate the identifier of the said desired network at a predetermined position in the said structured representation.

According to a further aspect of the present invention, there is provided a mobile radio communications user device arranged for selecting a desired network from a plurality of networks available though a single mobile radio communications network device, the device being arranged to receive a structured representation of network identifiers for the said plurality of networks and to select said desired network by means of the network identifier located at a predetermined position within the said structured representation.

Of course, it should be appreciated that the present invention can provide for a computer program, computer program product or computer readable medium comprising instructions for carrying out a method as defined above and as provided by the above mentioned mobile radio communications network device and/or mobile radio communication user device.

Within the above mentioned various aspects of the present invention, it should be appreciated that the said multi-network environment can comprise a shared network environment, for example comprising shared PLMNs and a E-UTRAN shared environment.

Also, the said structured representation can comprise a list, matrix and/or any required bit map representation of the network identifiers.

In one arrangement, the said predetermined position in the said structured representation can comprise the first position within a list of network identifiers, or a particular specified position within a list of network identifiers.

In an alternative arrangement, the said structured representation can comprise the first and the second position within a list of network identifiers and a 2-value indication to select the network identifier in one of these two positions, or the said representation can comprise a particular specified set of 2 or more positions, and an indication having N possible values where N is the number of positions in the set, selecting the network identifier in one of these N positions.

In one preferred arrangement, the method can include a further step of varying the position of at least two of the network identifiers within the structured representation so as to change the network identifier found at the said predetermined position.

In particular, the method can provide for periodic variations in the position of the said at least two network identifiers.

As will be appreciated, the invention proves particularly useful for the selection of a desired network by a mobile radio communications device operating in a limited service mode and seeking emergency bearer services from one, or more, of the plurality of networks.

The invention is described further hereinafter, by way of example only, with reference to the accompanying drawings in which:

### BRIEF DESCRIPTION DRAWINGS

FIG. 1 is a schematic representation of a E-UTRAN cell shared by six networks;

FIG. 2 is a schematic representation of a network device illustrated within the network arrangement of FIG. 1;

FIG. 3 is a schematic representation of a mobile radio communications user device arranged for operating within the network environment of FIG. 1: and

FIG. 4 is a signalling diagram illustrating network signalling arising in accordance with an embodiment of the present invention.

### DESCRIPTION OF EMBODIMENTS

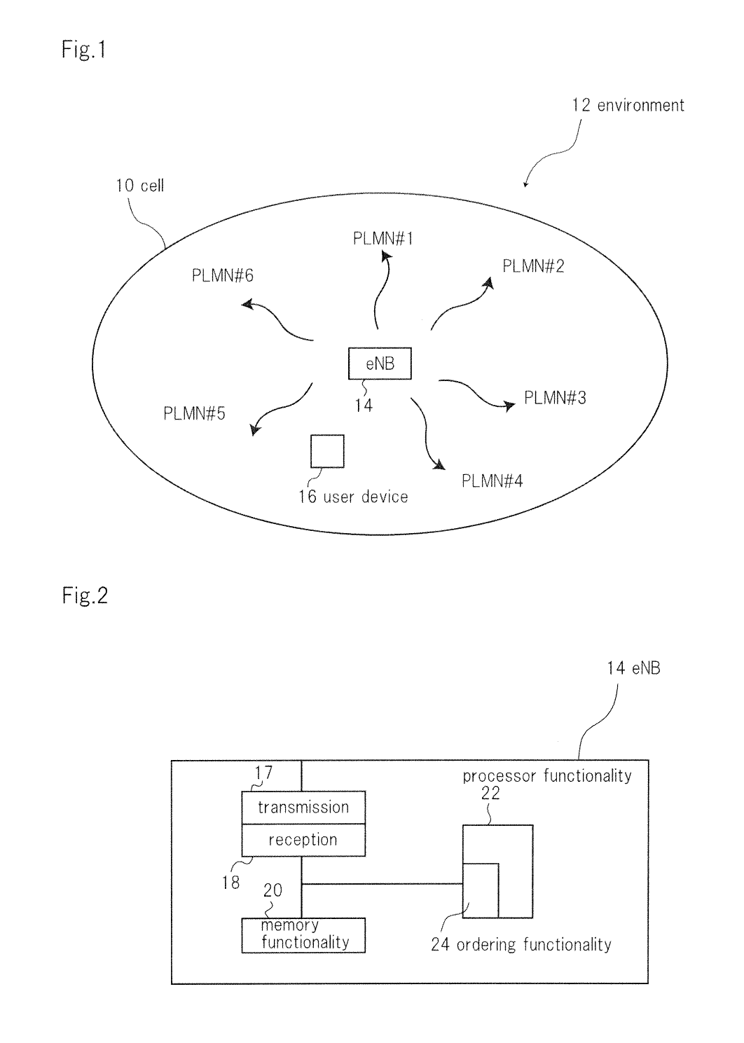

Turning first to FIG. 1, there is provided a schematic view of a shared E-UTRAN cell 10 and within a E-UTRAN environment 12. Within the cell 10, eNB 14 is shared by six different PLMNs, namely PLMN#1, PLMN#2, PLMN#3, PLMN#4, PLMN#5 and PLMN#6.

The network environment 12 therefore comprises a shared network environment and a user device such as mobile radio communications user device 16 located within the cell 10 has potential access to at least one of the said six PLMNs.

Within the illustrated example, the shared network environment is one within which the user device 16 can operate in limited service mode such that, for example, access to one or more of the six networks is provided for emergency bearer services only.

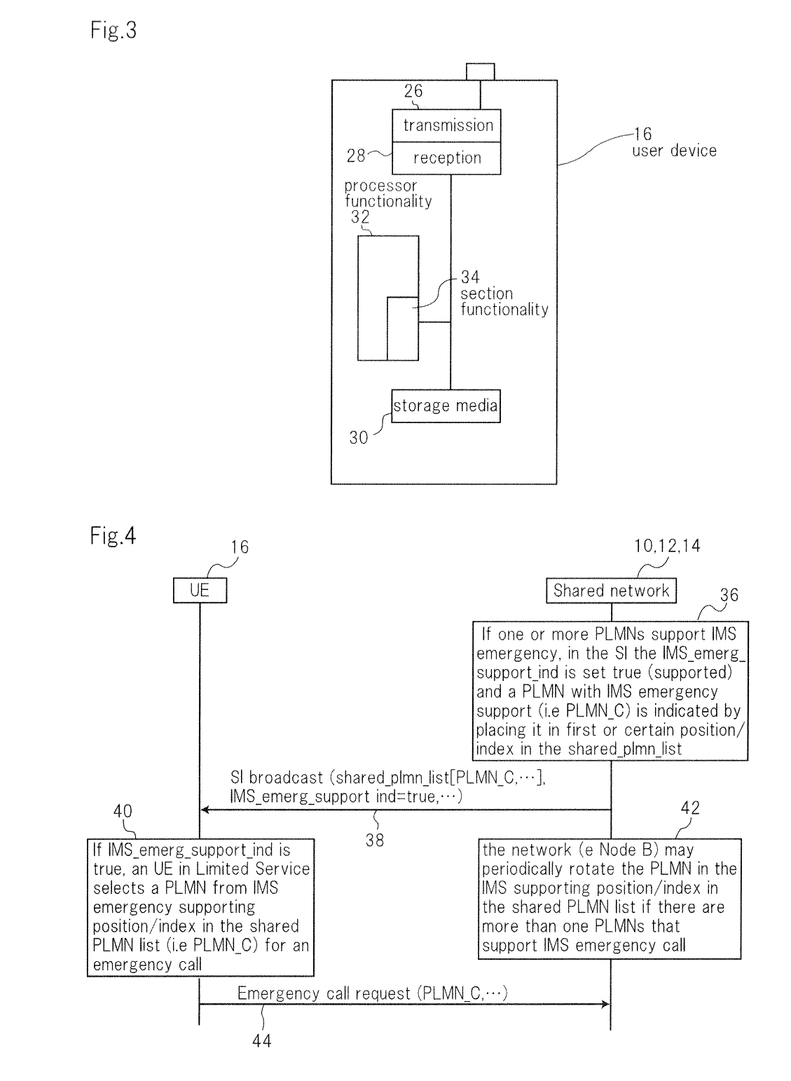

The operation of the present invention requires that the eNB 14 and the user device 16 have specific functionality which is discussed in further detail below with reference to FIGS. 2 and 3.

If it is assumed that one or more of the six PLMNs supports IMS emergency bearer services within the shared network environment the eNB 14 can be arranged to set the IMS in the SI to “true”, i.e. to indicate that such emergency services are supported. The signalling messaging from the eNB 14 serves to provide a network identifier for each of the six PLMNs and functionality within the eNB 14 serves to ensure that the identifier of an PLMN supporting IMS emergency services is located at a particular position within the representation of the network identifiers. For example, if the representation comprises a list of the network identifiers, the desired network, i.e. the, or a, network offering IMS emergency support is located first within the list. Alternatively, the desired network can be located at a certain predetermined position/index within the shared PLMN list.

Advantageously therefore, the user device 16 can select a PLMN that supports emergency bearer services so there is no need for the eNB 14 to select a different PLMN. In this manner, the MME/HSS and the user device will use the same PLMN and the derivation security/authentication procedure within the above mentioned IMS emergency procedure can be completed by way of only a single bit data overhead.

Even if two or three-bit bit maps are employed to identify the desired network to be selected b the User Device 16. this still represents a suitably limited overhead while enhancing the flexibility of positioning of the desired network identifier within the structured representation.

Turning now to FIG. 2, there is provided a schematic representation of the eNB 14 of FIG. 1. As noted, the eNB 14 is arranged to be shared by the 6 PLMNs of FIG. 1 and, within the SI broadcast by the eNB 14, there is provided a single bit indication as to whether one, or possibly more, of the PLMNs provide emergency bearer services. However, there are no further specific data bits serving to indicate which of the six PLMNs offer the desired emergency bearer services but, rather, and as will be appreciated from the above, it is the positioning of a PLMN offering that desired surface within the structured representation, such as a shared PLMN list, that serves to identify the desired PLM for ready selection and access by the user device 16.

The eNB also includes standard transmission 17 and reception 18 circuitry which is associated with memory functionality 20 and processor functionality 22 which includes, for example, ordering functionality 24 serving to locate the network identifier of a network having a predetermined desired characteristic such as an emergency bearer service at a predetermined position in the PLMN listing to be transmitted from the eNB 14 within the SI.

Turning now to FIG. 3, there is provided a schematic representation of a user device 16 which can be employed within the network environment of FIG. 1 to receive broadcast signalling from the eNB 14. As usual, the user device 16 employs transmission 26 and reception 28 circuitry and associated storage media 30 and processor functionality 32. Included within the processor functionality 32 there is provided selection functionality 34 which serves to identify the PLMN associated with the PLMN identifier found at a predetermined location within the shared PLMN list received within the IS broadcast from the eNB 14.

The location of the desired one or more PLMN identifiers within the PLMN shared list advantageously serves to assist the user device 16 in selecting any PLMN which offers the required IMS emergency support within the cell 10 but without the danger of the eNB 14 having selected a different PLMN.

Security and authentication procedures will therefore succeed and not exhibit the likely failure found in the current art.

Turning now to FIG. 4, there is provided a diagram illustrating signalling arising between the shared network 10, 12 and the user device 16.

As indicated at 36, if one or more PLMN within the shared network supports IMS emergency bearer services, the SI broadcast from the eNB 14 can includes an “emergency services supported” indication, i.e. a “true” flag and the identifier of the PLMN providing that emergency support is placed at a predetermined position within the shared PLMN list.

The SI signalling 38 containing such indicators is broadcast as illustrated to the user device 16.

Assuming that emergency support is indicated as present for that cell 10 of the shared network, the user device 16 then places the appropriate emergency call request to the correct PLMN.

As should therefore be appreciated, the invention provides for an advantageous feature over the current art since the network is advantageously arranged to ensure that the PLMN identified first in the list comprises one supporting IMS emergency calls, or the identifier is placed at a certain predetermined position/index within the shared PLMN list comprises the IMS emergency call supporting network and the relevant position is either fixed or indicated by way of a index value in the range 1 to 2, 1 to 3, 1 to 4, 1 to 5 or 1 to 6. This index can be represented as a numerical integer value binary-coded on 1, 2 or 3 bits according to the range, or as a set of specified values within a numerical values comprising other information. For example, a 2-bit value is used where one value (e.g. 00) indicates no support of IMS emergency call, a second value (e.g. 01) indicates support of IMS emergency in the first PLMN within the shared PLMN list, and a third value (e.g. 10) indicates support of IMS emergency call in the second PLMN within the shared PLMN list.

Alternatively, a 1-bit value is used where one value e.g. 0) indicates support of IMS emergency in the first PLMN within the shared PLMN list, and the second value (e.g. 1) indicates support of I MS emergency call in the second PLMN within the shared PLMN list.

Advantageously, a user device operating in limited service mode within a shared network then advantageously select the first, or appropriately located PLMN identifier so as to place an appropriate emergency call request to the network identified thereby.

As noted above, and if a plurality of the networks offer the required functionality, the network can advantageously, and if required periodically, vary the order within which the PLMN identifiers appear in the structured representation of the PLMNs that provide the desired characteristic, such as IMS emergency bearer services support.

It will therefore be appreciated that the present invention can provide for PLMN selection by a user device in limited service mode and in the shared network environment for IMS emergency call services.

1. A method of assisting selection by a mobile radio communications device of a desired network from a plurality of networks in a multi-network environment, the method including creating a structured representation of network identifiers for the plurality of networks respectively, and locating the identifier of the desired network at a predetermined position within the structured representation.

2. The method according to claim 1, wherein the multi-network environment comprises a shared network environment.

3. The method according to claim 1, wherein the structured representation comprises at least one of a list, matrix and/or any required bit-map representation of the network identifiers.

4. The method according to claim 3, wherein the predetermined position in the structured representation comprises the first position within a network list.

5. The method according to claim 3, wherein said predetermined position comprises a particular specified position within the list, matrix or bitmap representation.

6. The method according to claim 1, further including varying the position of at least two of the network identifiers within the structured representation so as to change the network identifier found at the predetermined position.

7. The method according to claim 6, further including periodically varying the position of the at least two network identifiers.

8. The method according to claim 1, for assisting with the selection of a desired network by a mobile radio communications device operating in a limited service mode and/or seeking emergency bearer services from one, or more, of the plurality of networks.

9. A mobile radio communications network device arranged to operate in a multi-network environment and for assisting selection by a mobile radio communications device of a desired network from a plurality of networks, the device further being arranged to create a structured representation of network identifiers for the plurality of networks respectively, and to locate the identifier of the desired network at a predetermined position within the structured representation.

10. The device according to claim 9, wherein the multi-network environment comprises a shared network environment.

11. The device according to claim 10, wherein the structured representation comprises at least one of a list, matrix and/or any required bit-map representation of the network identifiers.

12. The device according to claim 11, wherein the predetermined position in the structured representation comprises the first position within a network list or a particular specified position within the list or matrix or as identified by way of a bitmap representation.

13. The device according to claim 9, arranged to vary the position of at least two of the network identifiers within the structured representation so as to change the network identifier found at the predetermined position.

14. The device according to claim 13, further arranged to periodically vary the position of the at least two network identifiers.

15. The device according to claim 9, arranged for the selection of a desired network by a mobile radio communications device operating in limited service mode and/or seeking emergency bearer services from one of the plurality of networks.

16. A mobile radio communications device arranged for selecting a desired network from a plurality of networks within a multi-network environment, the device being arranged to receive a structured representation of network identifiers for the plurality of networks and to select the network by the network identifier located at a predetermined position within the structured representation.

17. The device according to claim 16, wherein the multi-network environment comprises a shared network environment.

18. The device according to claim 16, wherein the structured representation comprises at least one of a list, matrix and/or any required bit map representation of the network identifiers.

19. The device according to claim 18, wherein the predetermined position in the structured representation can comprises the first position within a list, or a particular specified position within the list, matrix or bitmap representation.

20. The device according to claim 16, arranged for the selection of a desired network when operating in a limited service mode and/or seeking emergency bearer services from one, or more, of the plurality of networks.

21. (canceled)

22. A method of selection by a User Device of a desired PLMN offering emergency bearer services from a list of PLMNs within a shared network environment, the method including creating a list of network identifiers for the plurality of PLMNs respectively, and locating the identifier of the desired PLMN at a predetermined position within the list.

23. A network node device arranged to operate in a shared network environment and for assisting selection by a User Device of a desired PLMN offering emergency bearer services from a plurality of PLMNs, the node device further being arranged to create a list of network identifiers for the plurality of PLMNs respectively, and to locate the identifier of the desired PLMN at a predetermined position within the list.

24. A user device arranged for selecting a desired PLMN offering emergency bearer services from any plurality of PLMNs within a shared network environment, the device being arranged to receive a list of network identifiers for the plurality of the PLMNs and to select the desired network by means of the network identifier located at a predetermined position within the list.

25. (canceled)

26. The device according to claim 9, further including:
transmission and reception circuitry which is associated with memory functionality; and
processor functionality which includes ordering functionality serving to locate the network identifier of a network having a predetermined desired characteristic such as including an emergency bearer service at a predetermined position in the PLMN listing to be transmitted from the device within the SI.

27. The device according to claim 16, further including:
transmission and reception circuitry and associated storage media; and
processor functionality which includes selection functionality which serves to identify the PLMN associated with the PLMN identifier found at a predetermined location within the shared PLMN list received within the IS broadcast from a mobile radio communication network device.
